(19) United States
(12) Patent Application Publication
(10) Pub. No.: US 2024/0096249 A1
(43) Pub. Date: Mar. 21, 2024

(54) Sign Device and System

(71) Applicant: Spirit Specialty Solutions Inc., Broomall, PA (US)

(72) Inventors: Michael Kurmlavage, Monroeville, NJ (US); Muhammad Jibran Arshad, Peshawar (PK)

(73) Assignee: Spirit Specialty Solutions Inc., Broomall, PA (US)

(21) Appl. No.: 18/454,240

(22) Filed: Aug. 23, 2023

Related U.S. Application Data
(60) Provisional application No. 63/406,852, filed on Sep. 15, 2022.
(60) Provisional application No. 63/406,857, filed on Sep. 15, 2022.
(60) Provisional application No. 63/406,863, filed on Sep. 15, 2022.
(60) Provisional application No. 63/406,868, filed on Sep. 15, 2022.

(51) Int. Cl. G09F 13/04

(52) U.S. Cl. CPC G09F 13/0446; G09F 13/0454

(57) ABSTRACT

A sign device for indicating to a customer a customizable message. The sign device includes a sign unit and a light source capable of displaying and illuminating a first sign. An arm extends from a lateral side of the sign unit, wherein the arm includes a foot member that secures to and slides the sign unit along a rail. The foot member allows the sign unit to rotate along a longitudinal axis. The sign unit is telescopic and can transition between a retracted configuration and an extended configuration. A retractable wire housing having a wire is in electronic communication with an electrical connector of the foot member that provides power to the sign. In some embodiments, the first sign is semi-translucent such that the light source illuminates through the first sign.

### CROSS REFERENCE TO RELATED APPLICATION

This application claims the benefit of U.S. provisional application No. 63/406,852 filed on Sep. 15, 2022, U.S. provisional application No. 63/406,857 filed on Sep. 15, 2022, U.S. provisional application No. 63/406,863 filed on Sep. 15, 2022, and U.S. provisional application No. 63/406,868 filed on Sep. 15, 2022; the above identified patent applications are herein incorporated by reference in their entirety.

### BACKGROUND OF THE INVENTION

The present invention relates to a sign device and system. The present invention further provides a sign device having a sign unit and a light source capable of displaying and illuminating a sign disposed within the sign unit. The sign unit is also configured to move along a rail of a cooking apparatus, such as a roller grill.

Many cooking grills and other cooking apparatuses at convenience stores are self-serve, allowing a customer to select a desired food item. These cooking apparatuses serve to cook, display, and keep warm multiple types of food items contained therein. The operator of the convenience store grills will place the items to be cooked, such as hot dogs, flavored sausage, and the like to the rear of a grill. Customers often rely on clear labeling and information about the food they consume because it can be difficult for a customer to identify the food item or the flavor of food item by looking at the food item alone. Self-serve convenience store setups may lack proper labeling or allergen information, making it difficult for customers to make informed choices or avoid allergens that could be present in the food. Additionally, a customer may be uncertain if the food item desired is fully cooked or still cooking.

Conventionally, customers of self-serve stations are completely reliant on the operator or convenience store employee to manually update the food signage. Relying on employees for properly managing all the food signage can lead to human error due to potential forgetfulness or mismanagement. Unfortunately, ill-lit and mismanaged self-serve food signage can lead to cross-contamination, customers inadvertently choosing the incorrect food, overcooked or undercooked food items, and more. Therefore, there is a need in the art for a device to indicate to the customer the identity of the food item and/or if the food item is fully cooked or still cooking.

In light of the devices disclosed in the known art, it is submitted that the present invention substantially diverges in design elements and methods from the known art and consequently it is clear that there is a need in the art for an improvement for a sign device. In this regard the instant invention substantially fulfills these needs.

### SUMMARY OF THE INVENTION

In view of the foregoing disadvantages inherent in the known types of sign devices now present in the known art, the present invention provides a new sign device that comprises a sign housing having a foot member configured to slide along a rail and indicate to a consumer a type of food item displayed, wherein the sign unit is rotatable along a longitudinal axis.

It is an objective of the present invention to provide a sign device wherein the sign unit comprises an arm extending from a lateral side thereof, wherein the arm includes a foot member that secures to and slides the sign unit along a rail of a cooking apparatus.

It is another objective of the present invention to provide a sign device comprising a second sign unit, wherein the foot member of the first sign unit extends from a front side thereof and the foot member of the second sign unit extends from a rear side thereof, such that the feet are offset from one another enabling the signs to align side by side while secured to a same rail.

It is another objective of the present invention to provide a sign device wherein the sign unit is telescopic and is adapted to transition between a retracted configuration and an extended configuration.

It is another objective of the present invention to provide a sign device comprising a light source capable of displaying and illuminating a sign, wherein the light source is powered via an electrical connector securable to the foot member. The electrical connector comprises a wire that is retractably stored within a wire housing.

It is yet another objective of the present invention to provide a sign device further comprising a cooking apparatus, such as a roller grill. The roller grill comprises a housing having a main body and a pair of sidewalls extending above the body and further includes front, back, side, and upper surfaces, a plurality of spaced apart tubular rollers disposed between the sidewalls, and a heating element. Positioned on top of the roller grill assembly is the food separating device, comprising a pair of support brackets for supporting the food separating device on the roller grill sidewall upper surfaces, a pair of crossover bars, and a plurality of separator rails that extend perpendicular to the rollers.

It is therefore an object of the present invention to provide a new and improved sign device that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the sign device.

FIG. 2 shows a perspective view of an embodiment of the sign device, wherein a sign unit is in an extended configuration.

FIG. 3A shows a perspective view of a sign unit of an embodiment of the sign device.

FIG. 3B shows a perspective view of an arm of a sign unit of an embodiment of the sign device.

FIG. 4 shows a perspective view of a clip and foot member of an embodiment of the sign device.

FIG. 5 shows an overhead view of a first sign unit adjacent to a second sign unit of an embodiment of the sign device.

FIG. 6 shows a close-up view of an embodiment of the sign device.

### DETAILED DESCRIPTION OF THE INVENTION

Reference is made herein to the attached drawings. Like reference numerals are used throughout the drawings to depict like or similar elements of the sign device. For the purposes of presenting a brief and clear description of the present invention, the embodiment discussed will be as used for a first and second sign unit each having a sign configured to align side by side when a foot member of each sign unit is positioned on a same rail. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

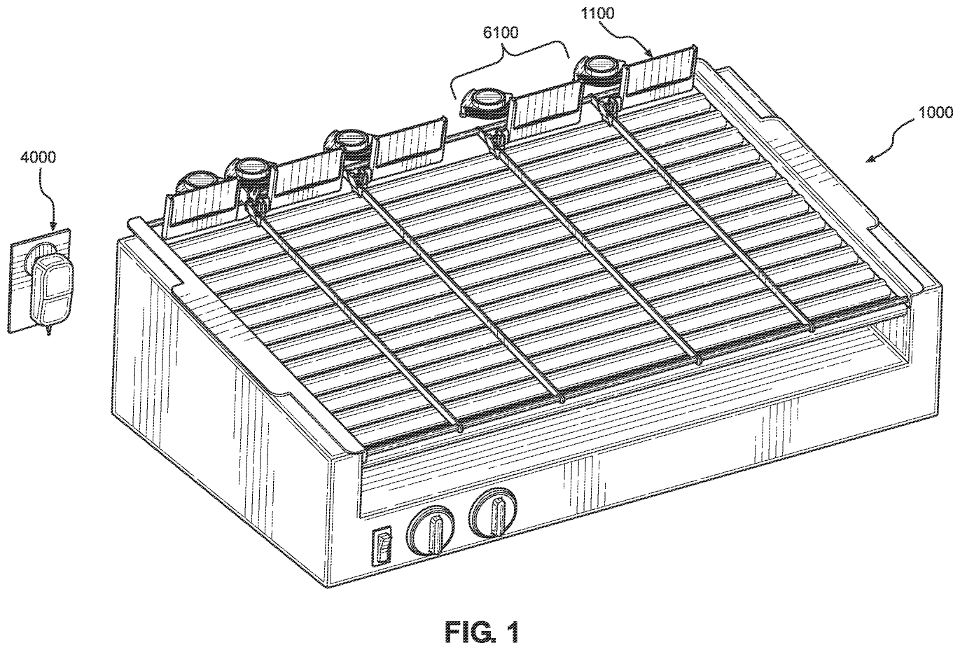

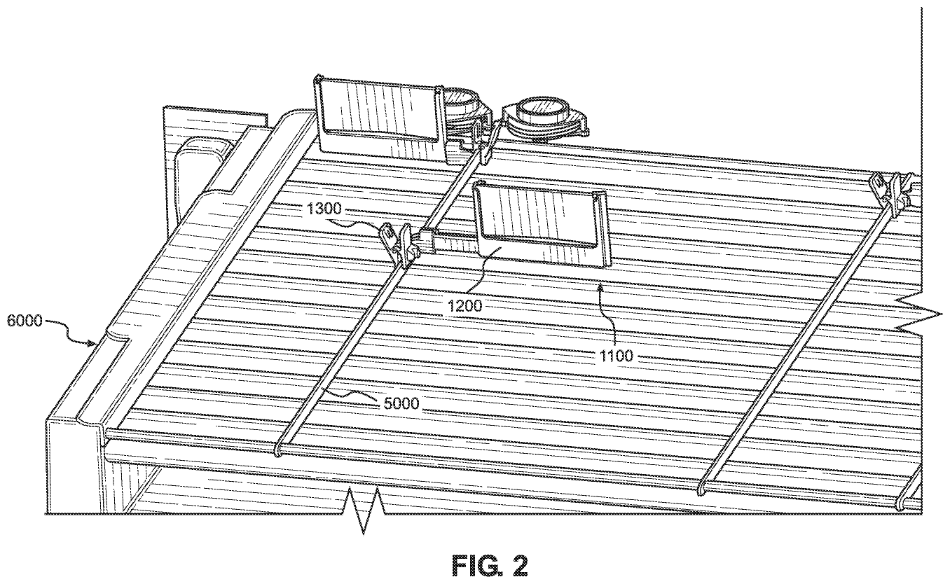

Referring now to FIGS. 1 and 2, there is a perspective view of an embodiment of the sign device and a perspective view of an embodiment of the sign device, wherein a sign unit is in an extended configuration, respectively. In the illustrated embodiment, the sign device 1000 comprises a sign unit 1100 configured to be positioned within a cooking column 6100 of a cooking apparatus 6000 or roller grill. The sign unit 1100 is adapted to receive and display a sign for conveying to a customer information about a food product positioned within the cooking column. In some embodiments, the sign device 1000 comprises the cooking apparatus, wherein other embodiments, the sign device does not include the cooking apparatus.

In the illustrated embodiment, the sign unit 1100 comprises an arm 1200 extending from a lateral side thereof. The arm 1200 is configured to retract and extend within the sign unit (as seen in FIG. 2). A foot member 1300 extends from the arm 1200 and is configured to engage with a rail 5000 that separates one cooking column from an adjacent cooking column of the cooking apparatus 6000. In the illustrated embodiment, the rail 5000 extends from a lower side to an upper side of the cooking apparatus 6000, allowing the sign unit to move between the lower side and the upper side of the cooking apparatus. In the illustrated embodiment, the rail comprises a circular cross section and a smooth surface to allow the foot member to slide therealong. In other embodiments, the rail comprises a track wherein the foot member is disposed within the track and is movable therealong.

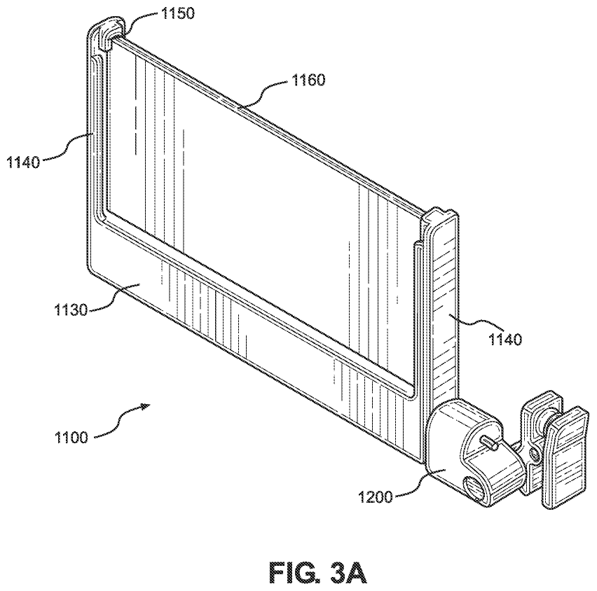

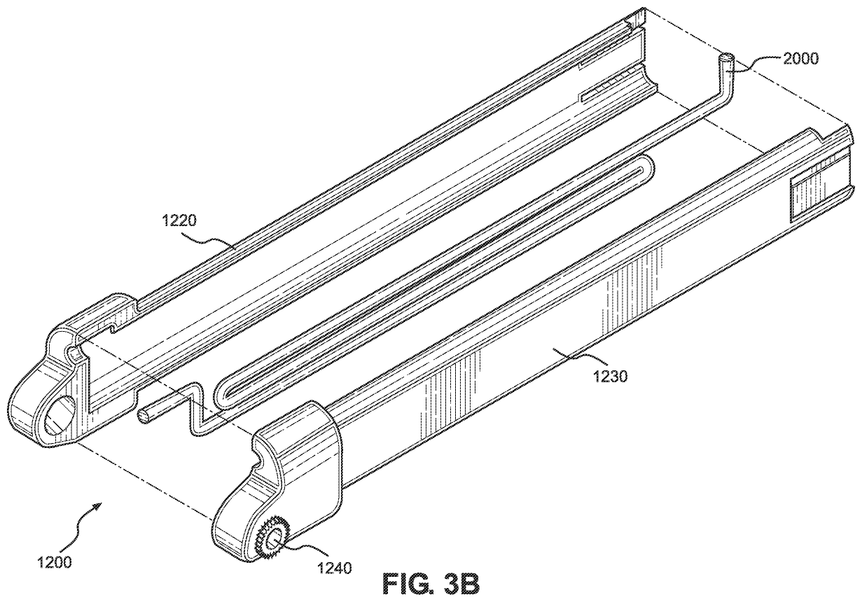

Referring now to FIGS. 3A and 3B, there is shown a perspective view of a sign unit of an embodiment of the sign device and a perspective view of an arm of a sign unit of an embodiment of the sign device, respectively. In the illustrated embodiment, the sign unit 1100 comprises a base 1130 with two vertical support members 1140 forming a sign receiver 1150 adapted to removably receive a first sign 1160. The base 1130 extends perpendicularly relative to the support members 1140 and comprises an interior volume adapted to house a wire 2000 that allows continuous electrical power to be delivered to a light source. In the illustrated embodiment, the wire 2000 is disposed within the interior volume of base 1130 in a serpentine configuration. The wire 2000 is housed within the arm 1200 that is received within the interior volume of the base 1130. In this way, the wire remains operational in both the extended and retracted configurations. In the illustrated embodiment, the base 1130 comprises a substantially rectangular cross section. However, in alternate embodiments, the base comprises any suitable shape. Referring specifically to FIG. 2, there is shown an embodiment of the arm 1200 formed by two shells 1220, 1230 joined together to house the wire 2000. The arm 1200 includes a pivot 1240 that is adapted to angle the arm 1200, and the sign unit 1100 respectively.

In the illustrated embodiment, the sign receiver 1150 forms a slot or void configured to receive and retain the first sign 1160 therein. However, in alternate embodiments, the sign receiver 1150 is configured to secure a sign therein via any suitable fastener, such as a magnet, interlocking fastening member, and the like. The sign 1160 is configured to be position along a majority of a face of the respective side of the sign unit 1100. In other embodiments, the sign is integral to each side of the sign unit, wherein some embodiments, the sign is removably and magnetically secured over the face of each side of the sign unit. The present invention contemplates many ways in which to removably or permanently secure a sign to a side of the sign unit via the sign receiver 1150 and the embodiments described herein are not intended to limit the manner in which the sign can be secured to the sign unit. In another embodiment, the sign unit includes a substrate which provides for printing thereon.

In some embodiments, the first sign indicates a type or flavor of food item, such as a hot dog, sausage, filled sausage, pizza, chicken, burger, breakfast sandwich, and the like. In other embodiments, the first or a second sign indicates whether the food item indicated within the sign is safe to eat.

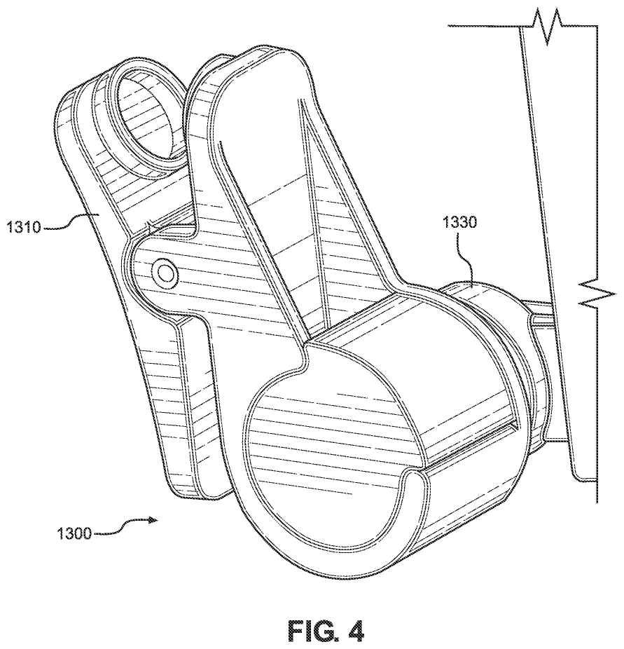

Referring now to FIG. 4, there is shown a perspective view of a clip and foot member of an embodiment of the sign device. In the illustrated embodiment, the foot member 1300 comprises a clip 1310 biased to semi-permanently secure the sign unit housing to the rail. The foot member 1300 is offset from the base 1130 along a horizontal plane such that the foot member 1300 is accessible on a front or rear side thereof (as seen in FIG. 3A). The clip 1310 can be easily manually removed from the rail and placed in a different position along the same rail or a different rail. In the illustrated embodiment, the foot member 1300 further comprises a rotatable shoulder 1330 operably connected to the arm and disposed within a first side of the clip 1310. The first side of the clip 1310 is proximate to the sign unit, whereas the second side of the clip is disposed within the adjacent cooking column when secured to the rail. The shoulder 1330 is configured to rotate the sign unit along a longitudinal axis. In this configuration, the sign is adapted to rotate about the shoulder when the clip is secured to the rail. In other embodiments, the shoulder of the foot member is flexible or a ball joint allowing the sign unit to move along a plurality of axis. In the illustrated embodiment, the shoulder is configured to rotate the sign unit 360 degrees, wherein alternate embodiments, the shoulder is configured to rotate the sign unit less than 360 degrees.

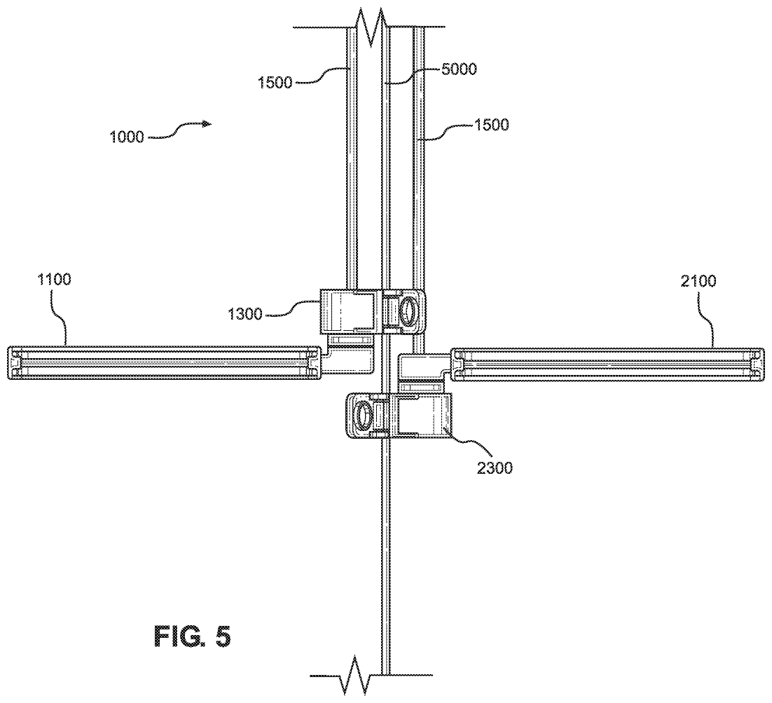

Referring now to FIG. 5, there is shown an overhead view of a first sign unit adjacent to a second sign unit of an embodiment of the sign device. In the illustrated embodiment, the sign device 1000 comprises a first sign unit 1100 and a second sign unit 2100, wherein the foot member 1300 of the first sign unit 1100 extends on a front side thereof and the foot member 2300 of the second sign unit 1300 extends from a rear side of the second sign unit. In this way, the foot member of one sign unit 1100 will be offset from a foot member of an adjacent sign unit 2100 to allow the adjacent signs to align side by side with one another. In the shown embodiment, the adjacent sign units 1100, 2100 are mounted to the same rail 5000. In alternate embodiments, the foot configuration can be switched such that the first sign unit foot member extends from the rear side of the sign and the foot member of the second sign unit extends from the front side of the sign.

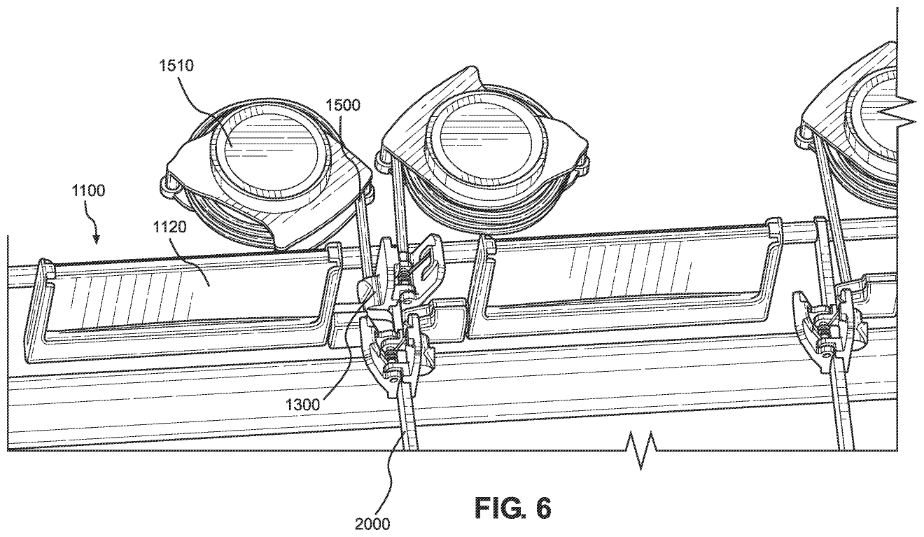

In the shown embodiment, the wire 1500 of the first and second sign units 1100, 2100 extend from the rear of the system. The wire 1500 is in electronic communication with each sign unit 1100, 1200 independently. In one embodiment, the wire 1500 extents over a top side of the roller grill and is suspended thereabove. The wire 1500 is housed within a retractable wire housing, as shown in FIG. 6, wherein the wire housing is a self-retracting reel that maintains tension on the wire 1500 to keep the wire 1500 above the heating element of the grill.

Referring now to FIG. 6, there is shown a close-up view of an embodiment of the sign device. In the illustrated embodiment, the sign unit 1100 comprises a light source adapted to illuminate the first sign 1120. In some embodiments, the first sign is composed of a semi-translucent material such that the light source illuminates through the first sign positioned within the sign receiver. In other embodiments, the light source comprises a diffuser adapted to illuminate a lateral side of the first sign received within the sign receiver.

In the illustrated embodiment, the foot member 1300 further comprises an electrical connector (as seen in FIG. 4, 1335) configured to electronically couple the sign unit to an external power source (as seen in FIG. 1, 4000) via a wire 1500. In the shown embodiment, a retractable wire housing 1510 is positioned along an end of the rail 2000 and adapted to retractably store the wire 1500 therein. The wire 1500 is in electronic communication with the electrical connector of the foot member 1300. In the illustrated embodiment, the wire 1500 is disposed along an exterior side of rail, wherein alternate embodiments, the wire is disposed within the rail, thereby concealing the wire. In some embodiments, the wire is removable from the foot member. In other embodiments, the wire is waterproof and heat resistant to withstand the heat and fluid that may be produced from the operation of the cooking apparatus. In some embodiments, the sign device comprises an integral power source for powering the light source and/or movement of the sign unit.

In some embodiments, the sign unit is configured to be moved and rotated manually, whereas in other embodiments, the sign unit is moved and rotated automatically, via the electrical connection, after an occurrence of an event, such as a predetermined amount of time has elapsed, a timer has activated, an internal temperature of the food item has been achieved, and the like.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A sign device, comprising:
a sign unit configured to display a first sign;
a light source adapted to illuminate the first sign;
a foot member disposed on the sign unit, wherein the foot member is adapted to secure to along an elongated member.

2. The sign device of claim 1, wherein the sign unit comprises a base with two vertical support members forming a sign receiver adapted to removably receive the first sign.

3. The sign device of claim 2, wherein the first sign is semi-translucent such that the light source illuminates through the first sign positioned within the sign receiver.

4. The sign device of claim 2, wherein the light source comprises a diffuser to illuminate a lateral side of the first sign received within the sign receiver.

5. The sign device of claim 1, wherein the sign unit is telescopic and adapted to transition between a retracted configuration and an extended configuration.

6. The sign device of claim 5, wherein the base comprises an interior volume adapted to house a wire in a serpentine configuration that allows continuous electrical power to be delivered to the light source in both the retracted and extended configurations.

7. The sign device of claim 1, wherein the foot member is adapted to pivot the sign unit along a longitudinal axis.

8. The sign device of claim 1, wherein the foot member comprises a clip biased to semi-permanently secure the sign device to the elongated member.

9. The sign device of claim 1, wherein the foot member is horizontally offset from the base such that the foot member is accessible on a front or rear side thereof.

10. The sign device of claim 1, wherein the foot member comprises an electrical connector to electronically couple the sign housing to an external power source.

11. The signage system of claim 1, further comprising a retractable wire housing that includes a wire in electronic communication with the electrical connector of the foot member, the wire being removable, waterproof, and heat resistant.

12. A signage system for use with a roller grill, comprising:
a sign unit configured to display a first sign;
a light source adapted to illuminate the first sign;
wherein lateral side of the sign unit engages with an arm;
a foot member disposed on the arm, wherein the foot member is adapted to secure to and slide along a rail of a food separating device;
wherein the foot member is horizontally offset from the base such that the foot member is accessible on a front or rear side thereof;
wherein the first sign is configured to rest on a same plane as a second sign secured to the same rail in an adjacent column.

13. The sign device of claim 1, wherein the sign unit comprises a base with two vertical support members forming a sign receiver adapted to removably receive the first sign.

14. The sign device of claim 13, wherein the first sign is semi-translucent such that the light source illuminates through the first sign positioned within the sign receiver.

15. The sign device of claim 13, wherein the light source comprises a diffuser to illuminate a lateral side of the first sign received within the sign receiver.

16. The sign device of claim 12, wherein the sign unit is telescopic and adapted to transition between a retracted configuration and an extended configuration.

17. The sign device of claim 16, wherein the base comprises an interior volume adapted to house a wire in a serpentine configuration that allows continuous electrical power to be delivered to the light source in both the retracted and extended configurations.

18. The sign device of claim 12, wherein the foot member is adapted to pivot the sign unit along a longitudinal axis.

19. The sign device of claim 12, wherein the foot member comprises a clip biased to semi-permanently secure the sign device to the rail.

20. The sign device of claim 12, wherein the foot member comprises an electrical connector to electronically couple the sign housing to an external power source.
